(19) United States
(12) Patent Application Publication
(10) Pub. No.: US 2010/0259571 A1
(43) Pub. Date: Oct. 14, 2010

(54) ELECTRO-OPTICAL APPARATUS, DRIVING METHOD THEREOF AND ELECTRONIC DEVICE

(75) Inventor: Toshiyuki KASAI, Okaya-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/756,673

(22) Filed: Apr. 8, 2010

(30) Foreign Application Priority Data
Apr. 14, 2009 (JP) 2009-097714

(51) Int. Cl. G09G 5/10

(52) U.S. Cl. 345/691

(57) ABSTRACT

An electro-optical apparatus includes a plurality of unit circuits arranged to correspond to intersections of a plurality of scanning lines and a plurality of data lines, a plurality of control lines, a scanning line driving circuit which sequentially selects one scanning line in every driving period included in a unit period, and selects the plurality of control lines, and a data line driving circuit which outputs, data electric potentials corresponding to gradation data of the unit circuits corresponding to the scanning line selected in the driving period in the unit period, in every writing period included in each unit period before the driving period begins, wherein each plurality of unit circuits includes an electro-optical element, and a capacitor element which has a first electrode connected to a capacitor line through a first switching element and a second electrode connected to the electro-optical element through a second switching element.

### BACKGROUND

1. Technical Field

The present invention relates to an electro-optical apparatus including an organic EL (electro luminescent) element, a liquid crystal or the like, a driving method thereof and an electronic device.

2. Related Art

An electric-optical apparatus including an organic EL element or the like as an electro-optical element is provided in the related art. In the electro-optical apparatus, a variety of driving circuits is provided for supplying a predetermined electric current or voltage to the organic EL element or the like. Such a driving circuit may include, for example, a capacitor element which is connected in parallel with the organic EL element, in addition to the organic EL element. In this case, a data electric potential is supplied to a positive electrode of the organic EL element and one electrode of the capacitor element, and a reference electric potential is supplied to a negative electrode of the organic EL element and the other electrode of the capacitor element. According to this configuration, the supply of electric current due to electric charges, which correspond to the data electric potential and which are stored in the capacitor element, may be performed with respect to the organic EL element, and thus, driving of the organic EL element can be stably performed.

Such an electro-optical apparatus is disclosed, for example, in JP-A-2000-122608.

However, in the above described electro-optical apparatus, there are the following problems. That is, in order to obtain a sufficient light emitting amount of the organic EL element (a time integral value of light emitting luminance), it is necessary to increase the amount of electric charge stored in the capacitor element. Thus, it is necessary to remarkably increase the capacitance of the capacitor element. However, since the physical area for installation of each individual driving circuit is limited, it is difficult to realize such a large amount value.

Accordingly, in order to solve the problems, the present applicant has proposed a technology disclosed in U.S. Patent Application Publication No. 2009/0195534. Here, a capacitor element included in each of a plurality of driving circuits (unit circuits) is used for driving one organic EL element. As a simple example, in the case where the driving circuits are simply arranged only in one column and they are N in number (accordingly, the number of the capacitor elements and organic EL elements is also N), when driving any one organic EL element, firstly, charging according to a data electric potential corresponding to the organic EL element is concurrently performed with respect to N capacitor elements included in all the driving circuits, and then, concurrent discharging of the N capacitor elements (that is, electric current supply) is performed for the organic EL element.

With this configuration, there is hardly any trouble with respect to the above described problems.

However, the above described technology has room for improvement. That is, generally, in the above described electro-optical apparatus, it is necessary to have a function for controlling luminance of all images displayed by the organic EL element. In order to realize such a function, a related art technology employs, for example, a configuration in which a light emitting control transistor is installed between the organic EL element and a driving transistor of an electric current supply source for the organic EL element, and a driving circuit connects the elements in series. According to such a configuration, by controlling the time when the light emitting control transistor is in a turned on state, light emitting time of the organic EL element may be adjusted, thereby adjusting the luminance of all the images.

However, since such a light emitting control transistor does not exist in the technology disclosed in U.S. Patent Application Publication No. 2009/0195534, the above described configuration and method may not be employed.

### SUMMARY

An advantage of some aspects of the invention is that it provides an electro-optical apparatus capable of solving at least a part of the above problems, a driving method thereof, and an electronic device.

Further, the invention provides an electro-optical apparatus, a driving method thereof, and an electronic device capable of solving the above problems relating to the electro-optical apparatus, the driving method thereof, and the electronic device.

An electro-optical apparatus according to a first aspect of the invention includes: a plurality of unit circuits which is arranged to correspond to intersections of a plurality of scanning lines and a plurality of data lines; a plurality of control lines which is arranged to correspond to each of the plurality of scanning lines; a scanning line driving circuit which sequentially selects one scanning line in every driving period included in a unit period, and selects all or a part of the plurality of control lines; and a data line driving circuit which outputs, to the respective data lines, data electric potentials corresponding to gradation data of the unit circuits corresponding to the scanning line selected in the driving period in the unit period, in every writing period which is included in each unit period before the driving period begins, wherein each of the plurality of unit circuits includes: an electro-optical element which provides gradation corresponding to the data electric potential; and a capacitor element which has a first electrode connected to a capacitor line through a first switching element and a second electrode connected to the electro-optical element through a second switching element; wherein the first switching element is switched on when the control line is selected in the writing period to conduct between the capacitor line and the first electrode, and wherein the second switching element is switched on when the scanning line is selected by the scanning line driving circuit in the driving period to conduct the second electrode and the electro-optical element.

According to the first aspect of the invention, for example, the following operations may be performed.

That is, firstly, in the writing period, all or a part of the first switching elements are turned on to conduct the capacitor elements and the capacitor lines. In this case, it is preferable that the capacitor lines are set to a reference electric potential enabling charging in the capacitor elements when the capacitor lines and the first electrodes are in a turned on state. Further, the all or a part of first switching elements which are turned on correspond to all or part of a plurality of control lines, which are selected by the scanning driving circuits. According to the configuration, charging targets are only the respective elements corresponding to the first switching elements which are turned on, and thus, all the capacitor elements are not necessarily the charging targets.

Secondly, in the driving period after the writing period, discharging of the capacitor elements which are the charging targets in the above described first operation is performed with respect to the electro-optical elements included in the unit circuits corresponding to the one selected scanning line.

In such an operation, according to the number of selected control lines among the plurality of the control lines, that is, according to the number of the capacitor elements which are involved in the charging and discharging, the amount of electric current supplied to a certain electro-optical element is changed. Accordingly, luminance of the electro-optical element may be adjusted and thus luminance of all images may be also adjusted.

In the electro-optical apparatus according to the first aspect of the invention, all the plurality of control lines may not be concurrently selected in the one writing period.

According to the aspect of the invention, all the plurality of control lines is not concurrently selected at the same chance. In other words, a part of the plurality of control lines is necessarily selected among the plurality of control signals. Accordingly, the aspect of the invention is further apparent from the above description.

In this respect, the aspect of the invention does not necessarily to exclude a case that all the plurality of control signals is concurrently selected in the one writing period. This is because that such a case is obviously considered in the case where the electro-optical element emits light with the highest luminance. In interpreting the aspect of the invention, careful attention should be paid for such a case.

In the electro-optical apparatus according to the aspect of the invention, the control line which is not selected in the one writing period among the plurality of control lines may be regulated by a predetermined location relation with respect to the one scanning line selected in the driving period corresponding to the writing period, and the predetermined location relation may be constantly the same regardless of whether the one selected scanning line is any scanning line among the plurality of scanning lines.

According to the aspect of the invention, relation between the location of the electro-optical element which is the driving target and the location of the capacitor element involved in discharging when driving the electro-optical element may be constantly in a balanced state. For example, if it is simply assumed that only four unit circuits are arranged in one column, the “predetermined location relation” may be expressed, for example, as “◯◯◯” when the electro-optical element in the first unit circuit is the driving target (that is, when the scanning line corresponding to the electro-optical element is selected), as “◯◯◯” when the electro-optical element in the second unit circuit is the driving target, as “◯◯◯” when the electro-optical element in the third unit circuit is the driving target, and as “◯◯◯” when the electro-optical element in the fourth unit circuit is the driving target. In this respect, “◯” refers to the capacitor element involved in the discharging and “” refers to the capacitor element not involved in the discharging, respectively. The arrangement of “◯” or “” represents the arrangement of the unit circuits. (Here, the control line corresponding to the capacitor element involved in the discharging is selected and the control line corresponding to the capacitor element not involved in the discharging is not selected.) The “predetermined location relation” in such a case may be expressed as the “relation that the capacitor elements in two unit circuits are arranged next to the unit circuit including the electro-optical element which is the driving target are not used”.

According to the aspect of the invention, with respect to the electro-optical element which is the driving target, arrangement of the capacitor element involved in discharging (and charging) is well balanced, and even in the case where any one of the plurality of electro-optical elements emits light, an electric current supply condition becomes uniform, and thus, luminance irregularity or the like may be prevented.

Another specific aspect with respect to this aspect will be described hereinafter.

In this aspect, the predetermined location relation may include a relation that the one control line corresponding to the one scanning line adjacent to the one scanning line selected in the driving period is constantly not selected.

According to the aspect of the invention, using the above described symbols of “◯” and “”, for example, the predetermined location relation may be expressed as “◯◯◯” when the electro-optical element in the first unit circuit is the driving target, as “◯◯◯” when the electro-optical element in the second unit circuit is the driving target, as “◯◯◯” when the electro-optical element in the third unit circuit is the driving target, and as “◯◯◯” when the electro-optical element in the fourth unit circuit is the driving target. (This aspect also includes cases of “◯◯”, “◯◯”, “◯◯”, “◯◯” or the like.)

This aspect provides one of the most optimal examples on the basis of a balanced arrangement between the above described electro-optical elements and the capacitor elements involved in discharging.

Another specific aspect with respect to the aspect of the invention will be described hereinafter, together with the described previous aspect.

Further, in the electro-optical apparatus according to the aspect of the invention, the control line selected among the plurality of control lines may be constant for a predetermined period.

According to the aspect, for example, as in the previous two aspects, since it is not necessary to perform manipulation for changing the control line which is the selection target for every horizontal period, reduction in power consumption or the like may be achieved.

In this respect, the “predetermined period” may be freely set as, for example, one vertical period, a “P horizontal period” (P is an integer of which an upper limit is the number of the scanning lines), or “very long period” or the like. The latter expression is slightly ambiguous, but includes a case where there is no change in the control line which is the selection target during the electro-optical apparatus is used.

In the electro-optical apparatus according to the aspect of the invention, the predetermined period may correspond to one frame.

According to the aspect, since the predetermined period corresponds to one vertical period, firstly, as in the above described example, the number of the change manipulations is reduced compared with the case where the control line which is the selection target is changed for every horizontal period, and thus, power consumption may be reduced. Further, secondly, since the aspect may perform the change manipulation and may change the control line which is the selection target for every vertical period, in this aspect of the invention, the above described luminance irregularity reduction effect, that an electric current supply condition becomes uniform with respect to any electro-optical element, may be obtained.

According to the aspect of the invention, so-called opposite two effects can be achieved at the same time.

An electro-optical apparatus according to a second aspect of the invention includes: a plurality of unit circuits which is arranged to correspond to intersections of a plurality of scanning lines and a plurality of data lines; a capacitor line which is arranged to correspond to each of the plurality of scanning lines; a scanning line driving circuit which sequentially selects one scanning line in every driving period included in a unit period; and a data line driving circuit which outputs, to the respective data lines, data electric potentials corresponding to gradation data of the unit circuits corresponding to the scanning line selected in the driving period in the unit period, in every writing period which is included in each unit period before the driving period begins, wherein each of the plurality of unit circuits includes: an electro-optical element which provides gradation corresponding to the data electric potential; a capacitor element which has a first electrode connected to the capacitor line and a second electrode; and a second switching element which is arranged between the second electrode of the capacitor element and the electro-optical element and is switched on when the scanning line is selected by the scanning line driving circuit in the driving period to conduct the second electrode and the electro-optical element, wherein each capacitor line is connected to a plurality of third switching elements which correspond to the each capacitor line and is switched on in the writing period to conduct between the each capacitor line and a supplying line of a reference electric potential.

According to the aspect of the invention, function effects which are not essentially different from the function effects obtained by the electro-optical apparatus according to the above described first aspect of the invention are obtained.

Here, there are differences between the electro-optical apparatus according to the second aspect of the invention and the electro-optical apparatus according to the first aspect of the invention as follows. That is, firstly, in the first aspect of the invention, the first switching element is disposed between the first electrode of the capacitor element and the capacitor line, but in the second aspect of the invention, there is no first switching element. Secondly, in the first aspect of the invention, the first switching element is defined as an element included in the “each of the plurality of unit circuits”, but in the second aspect of the invention, the third switching element is defined as an element corresponding to the “each capacitor line”.

In the second aspect of the invention, according to the transition of the conduction and non-conduction states of each third switching element, transition of the conduction and non-conduction states between each capacitor line and the supply line of the reference electric potential is generated.

According to such a configuration, in the second aspect of the invention, according to the transition of the conduction and non-conduction states of each third switching element, the number of the capacitor elements involved in the charging and discharging is changed.

The above described various modifications defined in the first aspect of the invention may be similarly applied to the second aspect of the invention. In this case, the various modifications are focused on the selection and non-selection of the “control line”, but the second aspect of the invention may be focused on the conduction and non-conduction of the “third switching element”.

Further, an electronic device according to the invention includes the above described various electro-optical apparatuses.

Since the electronic device according to the invention includes the above described various electro-optical apparatuses, luminance of all the images may be easily adjusted.

In addition, there is provided a driving method of an electro-optical apparatus including a plurality of control lines which is arranged to correspond to each of a plurality of scanning lines, and a plurality of unit circuits, each unit circuit including an electro-optical element which provides predetermined gradation according to discharging of a capacitor element in the each unit circuit. The method includes: outputting a data electric potential to a plurality of data lines which are extended across the plurality of scanning lines; selecting all or a part of the plurality of control lines to conduct a first switching element between the capacitor element in the unit circuit corresponding to the selected control line and a capacitor line, so as to store electric charges according to the data electric potential in the capacitor element; and selecting one scanning line to conduct a second switching element between the electro-optical element in the unit circuit corresponding to the selected scanning line and the capacitor element.

According to the aspect of the invention, the electro-optical apparatus according to the aspect of the invention may be optimally driven.

### BRIEF DESCRIPTION OF THE DRAWINGS

The invention will be described with reference to the accompanying drawings, wherein like numbers reference like elements.

FIG. 1 is a block diagram illustrating an electro-optical apparatus according to a first embodiment of the invention.

FIG. 2 is a circuit diagram illustrating details of unit circuits and data electric potential generating units for forming the electro-optical apparatus in FIG. 1.

FIG. 3 is a timing chart for illustrating an operation of the electro-optical apparatus in FIGS. 1 and 2.

FIG. 4 is a diagram illustrating charging and discharging of a capacitor element in the electro-optical apparatus which is operated according to FIG. 3.

FIG. 5 is another diagram illustrating charging and discharging of the capacitor element in the electro-optical apparatus which is operated according to FIG. 3.

FIG. 6 is a diagram illustrating a temporal change in relation between locations of capacitor elements which become charging and discharging targets and locations of electro-optical elements which become light emitting targets, in the electro-optical apparatus according to the first embodiment of the invention.

FIG. 7 is a diagram illustrating a different example from FIG. 6, which is similar to the example in FIG. 6.

FIG. 8 is a diagram illustrating a configuration of a comparative example with respect to the configuration of the electro-optical apparatus according to the first embodiment of the invention.

FIG. 9 is a timing chart for illustrating an operation of the configuration of the comparative example in FIG. 8.

FIG. 10 is a circuit diagram illustrating details of unit circuits and data electric potential generating units for forming an electro-optical apparatus according to a second embodiment of the invention.

FIG. 11 is a timing chart for illustrating a modified example (fixing selected or non-selected charging control line) of an operation of the electro-optical apparatus according to the first and second embodiments of the invention, which is similar to the case in FIG. 3.

FIGS. 12A and 12B are diagrams illustrating modified examples (switching selected or non-selected charging control line for every frame) of an operation of the electro-optical apparatus according to the first and second embodiments of the invention, which is similar to the cases in FIGS. 6 and 7.

FIG. 13 is a diagram illustrating a modified example (every second selected or non-selected charging control line) of an operation of the electro-optical apparatus according to the first and second embodiments of the invention, which is similar to the cases in FIGS. 6, 7 and 12.

FIG. 14 is a circuit diagram illustrating details of unit circuits and data electric potential generating units for forming a modified example (addition of an auxiliary capacitor element) of the electro-optical apparatus according to the first and second embodiments of the invention.

FIG. 15 is a perspective view illustrating an electronic device to which an electro-optical apparatus according to embodiments of the invention is applied.

FIG. 16 is a perspective view illustrating another electronic device to which the electro-optical apparatus according to embodiments of the invention is applied.

FIG. 17 is a perspective view illustrating still another electronic device to which the electro-optical apparatus according to embodiments of the invention is applied.

### DESCRIPTION OF EXEMPLARY EMBODIMENTS

### First Embodiment

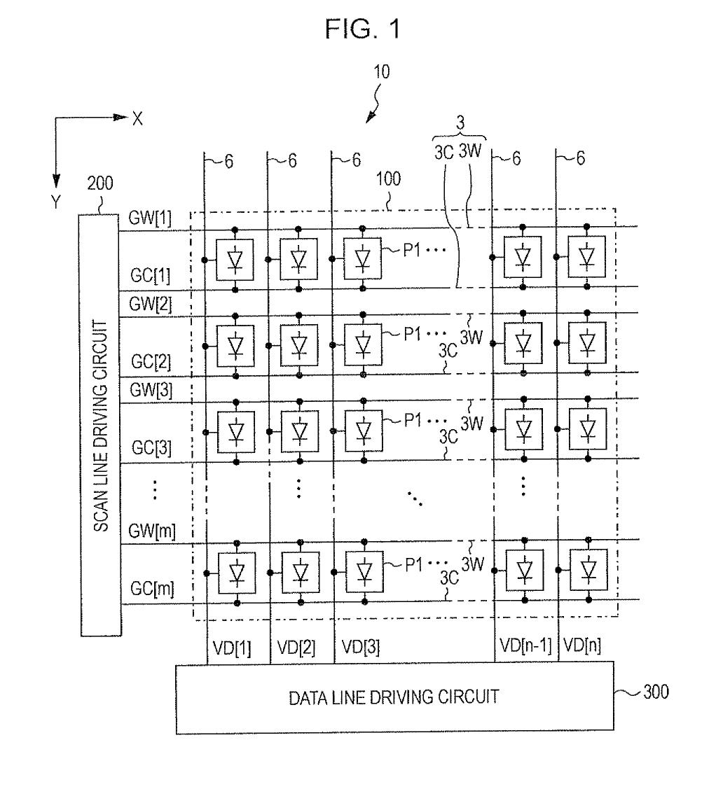

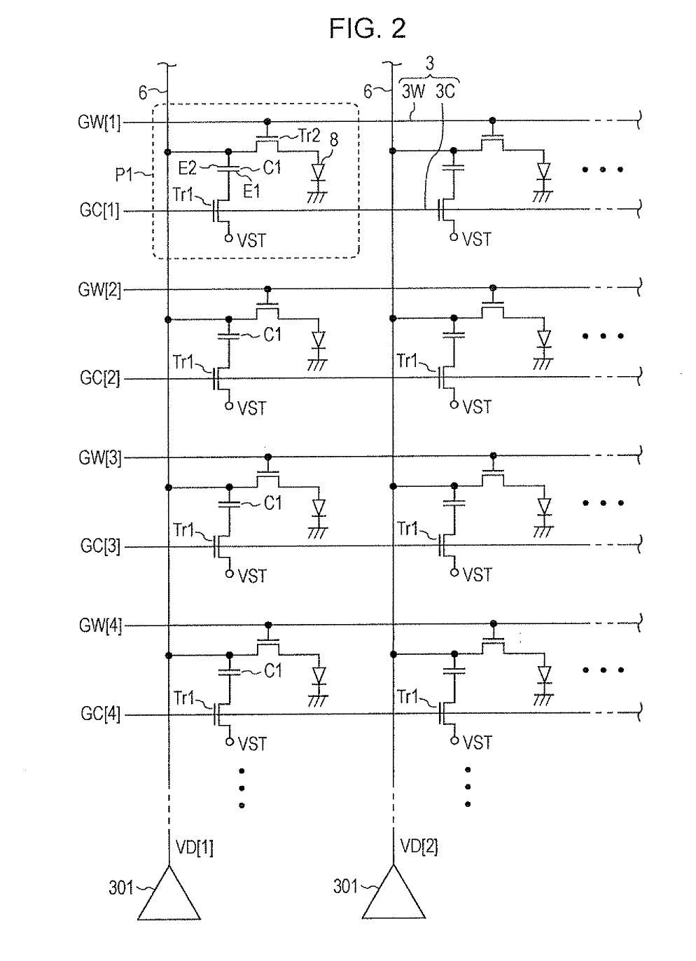

Hereinafter, a first embodiment according to the invention will be described with reference to FIGS. 1 and 2. In each drawing which will be referred to hereinafter, ratios of the sizes of respective parts may be different from those of real sizes.

In FIG. 1, an electro-optical apparatus 10 is an apparatus which is applied to a variety of electronic devices as a means for displaying images, and includes a pixel array unit 100 in which a plurality of unit circuits P1 is arranged in a planar shape, a scanning line driving circuit 200 and a data line driving circuit 300. In FIG. 1, the scanning line driving circuit 200 and the data line driving circuit 300 are illustrated as separate circuits, but a part or all of these circuits may be configured as a single circuit.

As shown in FIG. 1, m scanning lines 3 which are extended in an X direction and n data lines 6 which are extended in a Y direction perpendicular to the X direction are installed in the pixel array unit 100 (m and n are natural numbers). The respective unit circuits P1 are arranged in locations corresponding to intersections of the scanning lines 3 and the data lines 6. Accordingly, the unit circuits P1 are arranged in a matrix shape which is m rows long×n columns wide.

In the above configuration, the m scanning lines 3 each includes a pair of, that is, two light emitting control line 3W and charging control line 3C, as shown in FIG. 1. That is, if the number of the scanning lines 3 is m, the total number of the light emitting line 3W and the charging control line 3C is 2m. Further, the each control line (3W, 3C) is connected to each unit circuit P1 which is located in each row. (A detailed connection state will be described later with reference to FIG. 2.)

The “scanning line” defined in accompanying claims includes the “light emitting control line 3W” corresponding thereto, in the first embodiment of the invention.

The scanning line driving circuit 200 in FIG. 1 is a circuit for selecting the plurality of unit circuits P1. The scanning line driving circuit 200 generates light emitting control signals GW[1] to GW[m] which are sequentially active and outputs the generated light emitting control signals GW[1] to GW[m] to the respective light emitting control lines 3W. Transition to an active state of the light emitting control signal GW[i] which is supplied to the light emitting control signal 3W included in the scanning line 3 of an i-th row (i is an integer satisfying 1≦i≦m) refers to selection of n unit circuits P1 which belong to the i-th row.

Further, the scanning line driving circuit 200 generates charging control signals GC[1] to GC[m] which are appropriately active and outputs the generated charging control signals GC[1] to GC[m] to the respective charging control lines 3C. Transition to an active state of the charging control signal GC[i] which is supplied to the charging control line 3C included in the scanning line 3 of the i-th row refers to charging permission for capacitor elements C1 to be described later, which are included in the n unit circuits P1 which belong to the i-th row.

The supply of the light emitting control signal GW[i] for the light emitting control line 3W and the supply of the charging control signal GC[i] for the charging control line 3C may be independently performed, respectively.

The data line driving circuit 300 in FIG. 1 generates data electric potentials VD[1] to VD[n] according to respective gradation data of the n unit circuits P1 corresponding to the light emitting control lines 3W selected by the scanning line driving circuit 200, and outputs the generated data electric potentials VD[1] to VD[n] to the respective data lines 6. Hereinafter, the data electric potential VD which is output to the data line 6 of a j-th column (j is an integer satisfying 1≦j≦n) may be expressed as VD[j].

FIG. 2 is a circuit diagram illustrating a detailed electric configuration for the respective unit circuits P1.

Each unit circuit P1 includes an electro-optical element 8, a capacitor element C1, a first transistor Tr1, and a second transistor Tr2, as shown in FIG. 2.

The electro-optical element 8 is an OLED (Organic Light Emitting Diode) element in which a light emitting layer of an organic EL material is disposed between a positive electrode and a negative electrode, and is arranged between the second transistor Tr2 and a constant electric potential line (grounding wire) to which a constant electric potential is supplied, as shown in FIG. 2. Here, the positive electrode is installed for every unit circuit P1 and is an individual electrode controlled for every unit circuit P1, and the negative electrode is a common electrode commonly installed in the unit circuit P1. In addition, the negative electrode is connected to the constant electric potential line to which the constant electric potential is supplied. Alternatively, the positive electrode may be the common electrode and the negative electrode may be the individual electrode.

The capacitor element C1 is an element for storing the data electric potential VD [j] supplied from the data line 6. As shown in FIG. 2, the capacitor element C1 includes a first electrode E1 connected to the first transistor Tr1, and a second electrode E2 connected to the second transistor Tr2 and the data line 6.

The first transistor Tr1 is an N-channel type and is a switching element which is switched on when selecting the charging control line 3C to conduct the first electrode E1 of the capacitor element C1 and a supply line (not shown) of a reference electric potential VST. As shown in FIG. 2, a source of the first transistor Tr1 is connected to the supply line, and a drain thereof is connected to the first electrode E1 of the capacitor element C1.

Accordingly, a gate of the first transistor Tr1 is connected to the charging control line 3C. Thus, if the charging control signal GC[i] transits to an active state, the first transistor Tr1 which belongs to the i-th row is in a turned on state to conduct the first electrode E1 and the supply line, whereas if the charging control signal GC[i] transits to an non-active state, the first transistor Tr1 which belongs to the i-th row is in a turned off state to cut off the conduction of the first electrode E1 and the supply line.

The reference electric potential VST supplied to the supply line is preferably a fixed electric potential, and specifically, for example, is a ground electric potential. The “reference electric potential” is not limited thereto. For example, a negative electric potential may be supplied to the supply line. In this case, for example, a data electric potential VD[n] indicating the highest luminance among the data electric potentials VD[j] may be a positive electric potential and a data electric potential VD[1] indicating the lowest luminance among the data electric potentials VD[j] may be a negative electric potential. That is, the ground electric potential may be located between the data electric potential VD[n] and the data electric potential VD[1]. According to such a configuration, amplitude of the data electric potentials VD[j] with respect to the ground electric potential may be decreased and power consumption may be decreased.

In addition, FIG. 2 illustrates data electric potential generating units 301 included in the data line driving circuit 300 in FIG. 1. The data electric potential generating units 301 are installed to correspond to the respective data lines 6, as shown in FIG. 2, to individually generate and supply the data electric potential VD[j] for each data line 6.

The second transistor Tr2 is an N-channel type and is a switching element which is switched on when selecting the light emitting control line 3W to conduct the second electrode E2 of the capacitor element C1 and the electro-optical element 8. As shown in FIG. 2, a source of the second transistor Tr2 is connected to a positive electrode of the electro-optical element 8 and a drain thereof is connected to the second electrode E2 of the capacitor element C1.

Accordingly, a gate of the second transistor Tr2 is connected to the light emitting control line 3W. Thus, if the light emitting control signal GW[i] transits to an active state, the second transistor Tr2 which belongs to the i-th row is in a turned on state to conduct the second electrode E2 and the electro-optical element 8, whereas if the light emitting control signal GW[i] transits a non-active state, the second transistor Tr2 is in a turned off state to cut off the conduction of the second electrode E2 and the electro-optical element 8.

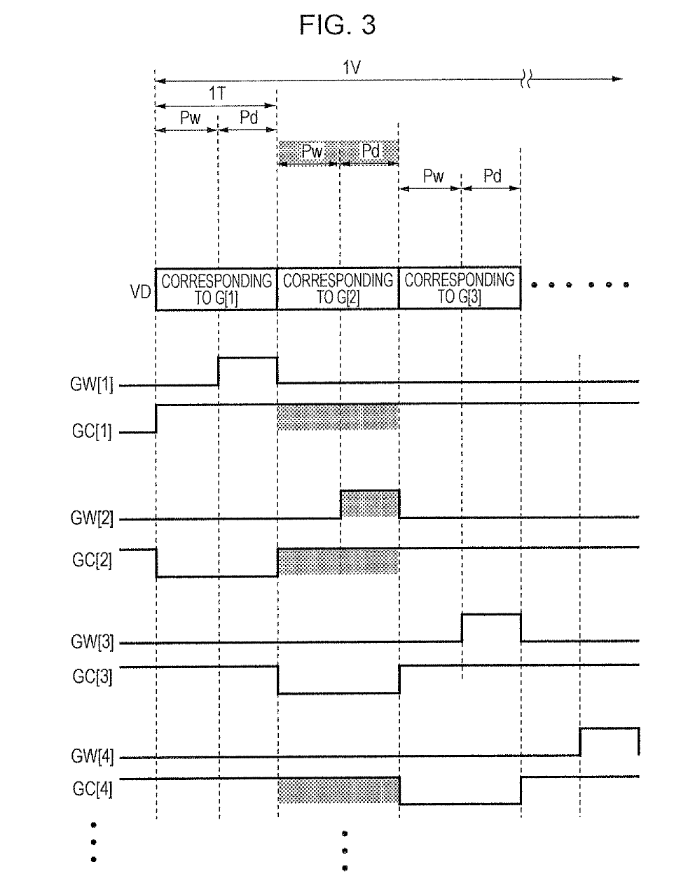

Next, an example of an operation or action of the electro-optical apparatus 10 according to the first embodiment will be described with reference to FIGS. 3 to 6, in addition to FIGS. 1 and 2.

The electro-optical apparatus 10 is based on the following operations “i” and “ii”.

i. Writing Operation

The writing operation is an operation that the data electric potential VD[j] corresponding to light emitting gradation of the electro-optical element 8 included in each unit circuit P1 corresponding to a certain scanning line 3 is stored in the capacitor elements C1 in the unit circuits P1 which belong to a column including the electro-optical element 8. For example, the data electric potential VD[3] for the electro-optical element 8 corresponding to the scanning line 3 in the second row and located in the third column (see FIG. 1) is stored in the plurality of capacitor elements C1 in the respective unit circuits P1 located in the third column. (Here, all the plurality of capacitor elements C1 is not necessarily used, which will be described later.)

ii. Light Emitting Operation (Driving of Electro-Optical Element)

The light emitting operation is an operation that the electro-optical element 8 emits light on the basis of the data electric potential VD[j] stored in the capacitor element C1 in the “i. Writing operation”. The operation is performed so that the active light emitting control signal GW[i] is supplied to the light emitting control line 3W included in the scanning line 3 corresponding to the unit circuit P1 including the electro-optical element 8, and thus, the second transistor Tr2 in the unit circuit P1 is turned on. Thus, the electro-optical element 8 is supplied with electric current corresponding to electric charges stored in the capacitor element C1, to emit light.

The electro-optical apparatus 10 according to the first embodiment basically operates on the basis of an appropriate combination of the above described “i” and “ii” operations, which will be described in more detail hereinafter by way of example.

Firstly, in a writing period Pw shown in the leftmost side in FIG. 3, the scanning line driving circuit 200 supplies active charging control signals GC[1], GC[3], GC[4], GC[m] to the charging control lines 3C other than the charging control line 3C included in the scanning line 3 located in the second row. Accordingly, the first transistor Tr1 located in each row other than the second row is in a turned on state to conduct the capacitor elements C1 which belong to each row and the supply line of the reference electric potential VST. Accordingly, the capacitor element C1 is opened from a floating state to be in a chargeable state.

Under such a situation, the data electric potential generating unit 301 generates the data electric potential VD[j] and supplies the generated data electric potential VD[j] to each corresponding data line 6. The data electric potential VD[j] corresponds to the electro-optical element 8 in each unit circuit P1 located in the first row (see “corresponding to G[1]” in FIG. 3).

In this way, the “i. Writing operation” is completed with respect to the electro-optical element 8 in each unit circuit P1 located in the first row. In the writing period Pw, among all the capacitor elements C1 in the pixel array unit 100, only the capacitor elements C1 other than the capacitor elements C1 which belong to the second row are involved in charging, and thus, the plurality of capacitor elements C1, which respectively belong to a first column, a second column, . . . , an n-th column, stores electric charges corresponding to the data electric potentials VD[1], VD[2], . . . , VD[n], respectively.

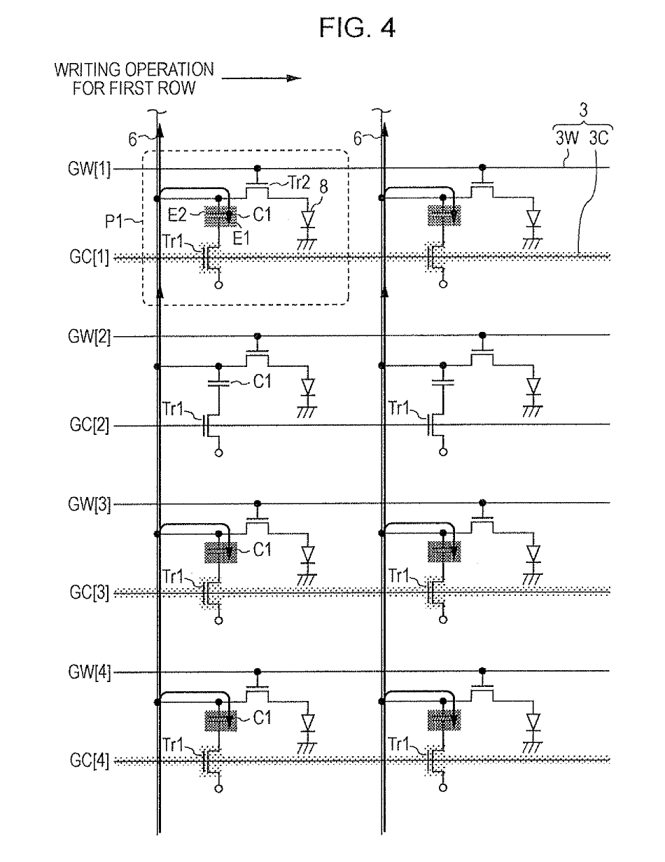

FIG. 4 illustrates the above described operations. That is, FIG. 4 illustrates a case that the plurality of capacitor elements C1 which belongs to each data line 6 stores electric charges corresponding to the VD[1], VD[2], . . . , VD[n] for every column (see thick arrows, solid arrows, shaded sections relating to the arrows, and the like in FIG. 4). In this case, the capacitor elements C1 located in the second row are not involved in such charging.

In this way, the “i. Writing operation” is completed with respect to the electro-optical element 8 in each unit circuit P1 located in the first row.

Next, in a driving period Pd adjacent to the writing period Pw, the scanning line driving circuit 200 supplies the active light emitting control signal GW[1] to the light emitting control line 3W included in the scanning line 3 in the first row. Thus, the electro-optical element 8 corresponding to the light emitting control line 3W concurrently emits light (“ii. Light emitting operation”). At this time, electric current flowing through the electro-optical element 8 corresponds to the amount of the electric charges stored in the plurality of capacitor elements C1. In this case, especially, the number of capacitor elements C1 involved in such discharging is the same as the number of the capacitor elements C1 involved in the above described charging. That is, in this case, the number of the capacitor elements C1 involved in the discharging is (m−1).

In this way, one unit period 1T is terminated (see an upper side in FIG. 3).

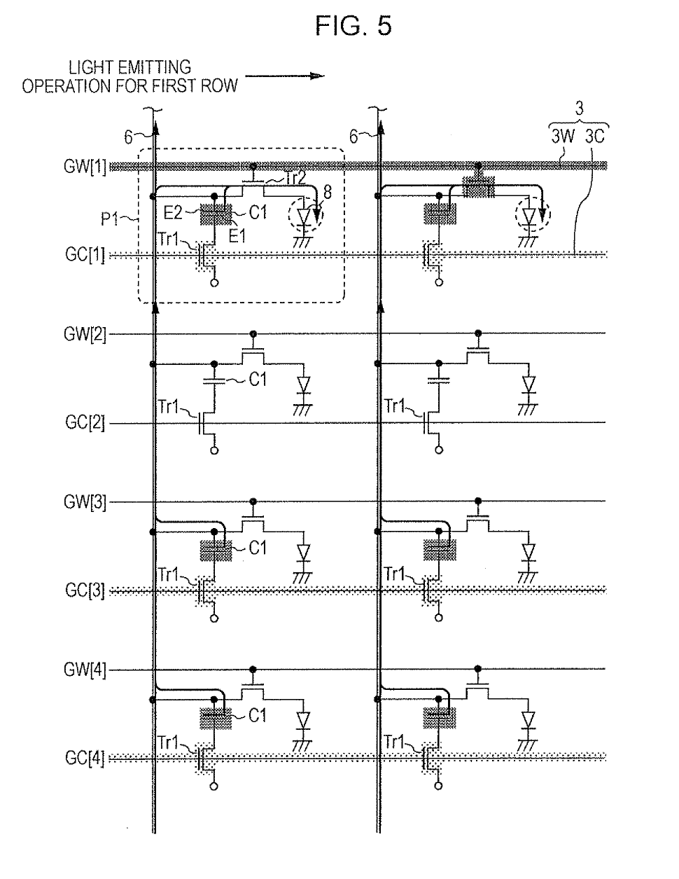

FIG. 5 illustrates the above described operations. That is, FIG. 5 illustrates a case that the active light emitting control signal GW[1] is supplied to the light emitting control signal 3W located in the first row, and thus, the second transistors Tr2 which belongs to the light emitting control signal 3W are in a turned on state so that the respective electro-optical elements 8 corresponding thereto emits light. In this respect, FIG. 5 also illustrates a case that electric current is supplied to the electro-optical element 8 according to electric charges of each of the capacitor elements C1 other than the capacitor elements C1 in the above described second row (see thick arrows, wave line arrows, shaded sections relating to the arrows, and the like in FIG. 5).

Thereafter, the above described operations are repeatedly performed while the electro-optical element 8 which is the light emitting target is sequentially shifted downward in FIGS. 4 and 5 (or FIGS. 1 and 2), that is, while the light emitting control line 3W is line-sequentially selected. A period IV in FIG. 3 refers to one vertical scanning period which is a period until all the light emitting control lines 3W are completely selected.

Here, during the repetition, careful attention should be paid for an operation of the charging control signal GC[1]. That is, the active charging control signals GC[1], GC[2], . . . , GC[i], GC[i+2], . . . , GC[m] are supplied to the respective charging control lines 3C other than an (i+1)th charging control line 3C, in the unit period 1T relating to the unit circuits P1 located in the i-th row. Here, when the unit circuit P1 which is the selection target is located in the final row (that is, m-th row), the charging control signals GC[2], . . . , GC[m] other than the charging control signal GC[1] become active. That is, the charging control line 3C which is not selected circulates.

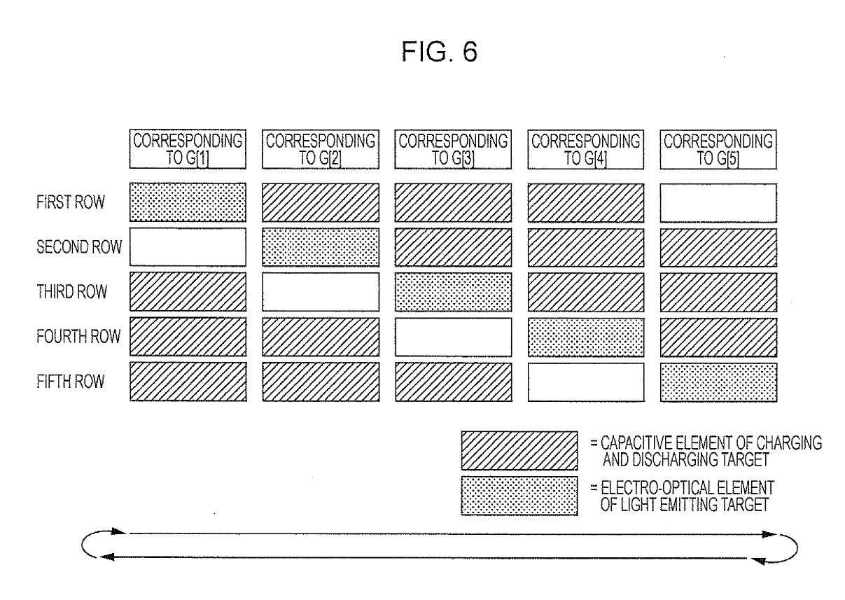

As a result, in the first embodiment, as shown in FIG. 3 or 6, the electro-optical elements 8 which are the light emitting target other than the electro-optical elements 8 which belong to the m-th row, are constantly supplied with electric charges discharged from the respective capacitor elements C1 other than the capacitor elements C1 which belong to the right next row. FIG. 6 is a diagram for schematically illustrating temporal change in relation between locations of the capacitor elements C1 which become the charging and discharging targets and locations of the electro-optical elements 8 which become the light emitting targets, in the case where there is the unit circuit P1 located only in the fifth row and the first column. In the figure, non-hatched quadrangles indicate the capacitor elements C1 which are not charged.

In the first embodiment of the invention, as well as the case of the above described “circulation”, relation expressed as “the charging control line 3C corresponding to the capacitor elements C1 which belongs to the right next row to the electro-optical element 8 which is the light emitting target (the first row in the case where the electro-optical element 8 which is the light emitting target is the m-th row) is not constantly selected” is provided as a specific example of the “predetermined location relation”.

Such a case is included in a specific example of a case of “the predetermined location relation is constantly the same regardless of whether the one selected scanning line is any scanning line among the plurality of scanning lines” in the embodiment of the invention. Here, in consideration of the “circulation”, for example, in the case of “corresponding to G[5]” and the case of “corresponding to G[1]” in FIG. 6, the “predetermined location relation” may not necessarily be the “constantly the same”. However, as long as such a consistent language expression is possible, the embodiment of the invention may include such a case as a specific example of the expression “constantly the same”.

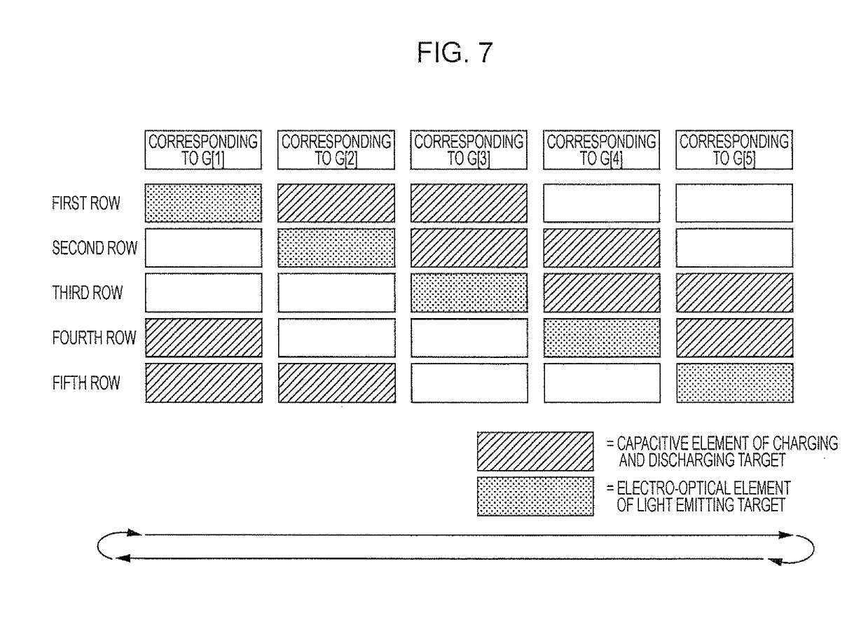

Further, the above described operation example is only a simple example. In the first embodiment, as the light emitting control line 3W is line-sequentially selected, how the charging control line 3C is selected is basically freely determined. For example, as shown in FIG. 7 which is similar to FIG. 6, in the unit period 1T relating to the unit circuits P1 located in the i-th row, the active charging control signals GC[1], GC[2], . . . , GC[i], GC[i+3], . . . , GC[m] may be supplied to the respective charging control lines 3C other than the charging control lines 3C located in the (i+1)th row and the (i+2)th row (circulation of the non-selected charging control lines 3C is the same as that in FIG. 6. See FIG. 7).

In the case of FIG. 7, compared with the case of FIG. 6, since the capacitor elements C1 which are involved in charging and discharging is reduced in number, luminance of all the images are lowered.

The electro-optical apparatus 10 in the first embodiment which performs such a configuration and operation has the following effects.

(1) Firstly, according to the electro-optical apparatus 10 in the first embodiment, as described above, since the number of capacitor elements C1 which supply electric charges to the electro-optical elements 8 which are the light emitting targets may be easily increased or decreased, luminance of all the images can be adjusted.

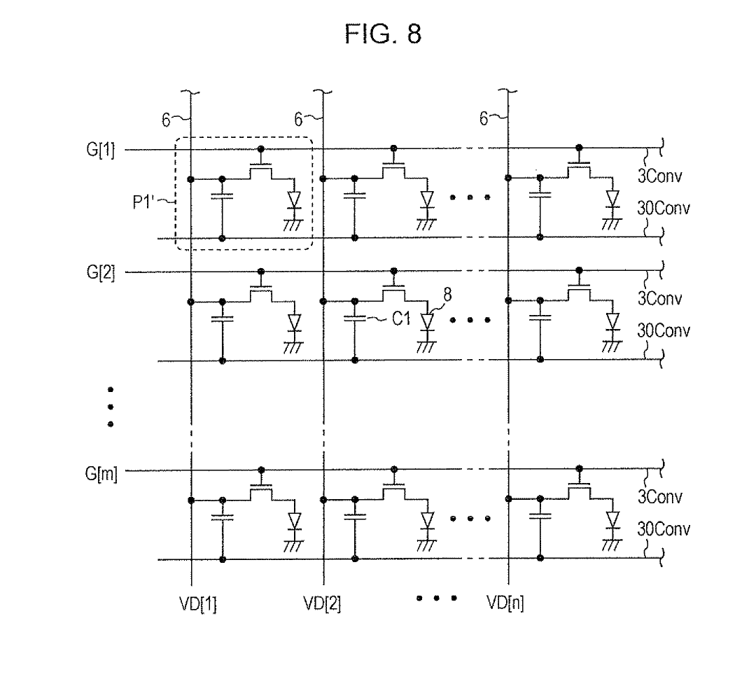

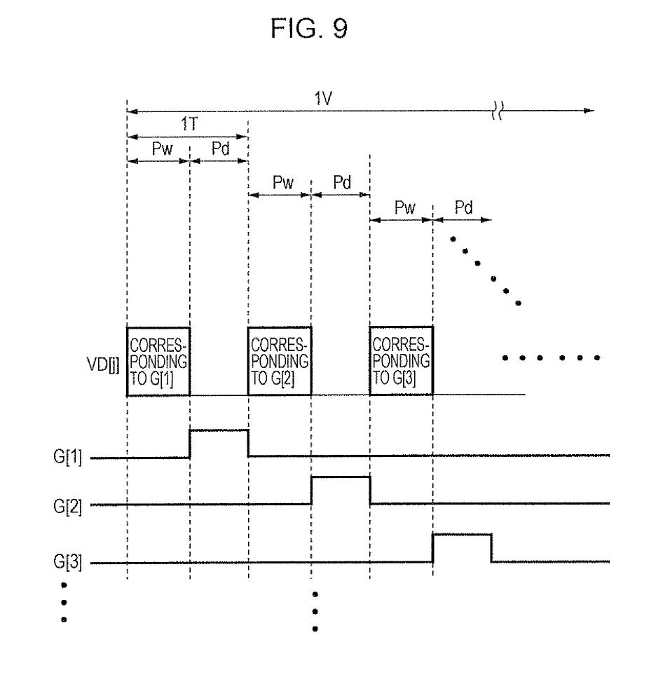

It is understood more clearly by comparing the first embodiment with FIGS. 8 and 9. FIG. 8 is a comparative example with respect to the configuration according to the first embodiment (refer to FIG. 2), and FIG. 9 is a timing chart for an operation of a configuration of the comparative example in FIG. 8 (refer to FIG. 3).

In FIG. 8, differently from FIGS. 1 and 2, every scanning line 3Conv is installed to correspond to each row of the unit circuit P1. In the first embodiment, the scanning line 3 corresponding to each row includes the light emitting control line 3W and charging control line 3C, respectively, but in the comparative example, there is only one wiring. Accordingly, a unit circuit P1′ in FIG. 8 does not include an element corresponding to the first transistor Tr1, differently from the unit circuit P1 in the first embodiment, and the capacitor element C1 is directly connected to a supply line 30Conv of a reference electric potential.

According to such a configuration in FIG. 8, the comparative example operates as shown in FIG. 9. In FIGS. 8 and 9, if a writing operation for the electro-optical element 8 which belongs to a certain row is performed, charging for all the capacitor elements C1 is concurrently performed, and if a light emitting operation for the electro-optical element 8 thereof is performed, discharging for all the capacitor elements C1 is concurrently performed. That is, according to such configuration and operation, luminance for all the images cannot be adjusted.

As is apparent from the above comparison, according to the first embodiment, such a problem does not occur.

(2) Further, according to the first embodiment, as described above, in the unit period 1T relating to the unit circuit P1 located in the i-th row, since the charging control line 3C of the (i+1)th row is not selected and the charging control line 3C which is the non-selection target circulates, relation between the location of the electro-optical element 8 which is the light emitting target and the location of the capacitor element C1 involved in the discharging is constantly in a balanced state (see FIG. 6 or 7). Accordingly, in the first embodiment, electric current supply conditions may be equalized with respect to any electro-optical element 8, and thus, luminance irregularity may be effectively prevented.

### Second Embodiment

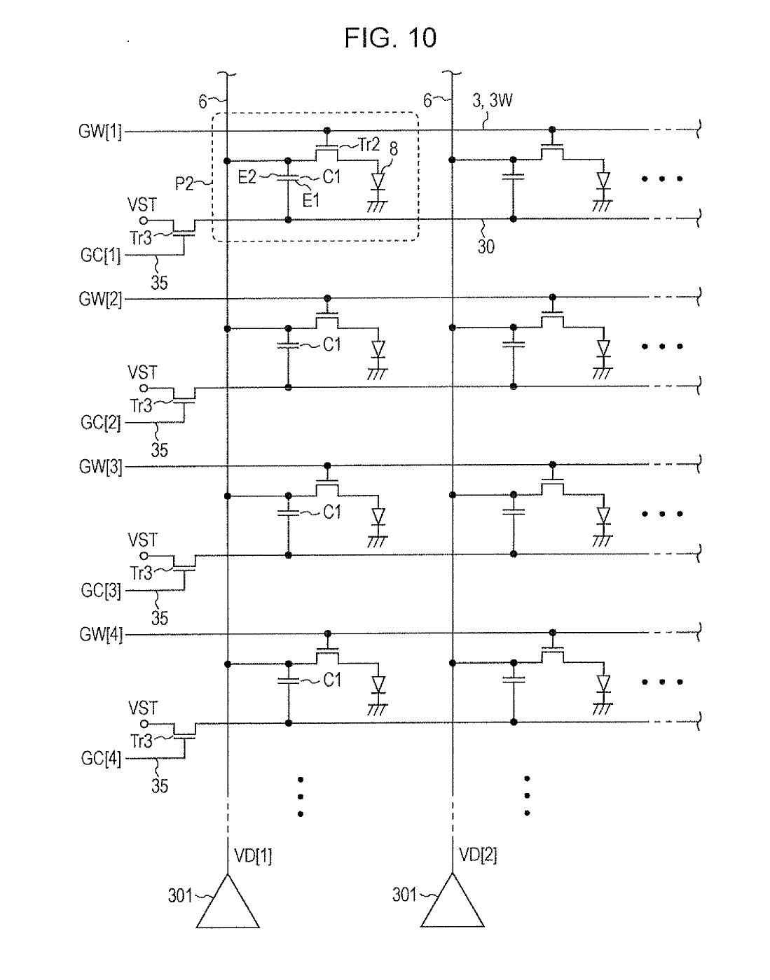

Hereinafter, a second embodiment according to the invention will be described with reference to FIG. 10. The second embodiment has a characteristic that a configuration of a unit circuit P2 is different from the first embodiment. Other configurations and operations or actions of the second embodiment are the same as those of the first embodiment. Accordingly, hereinafter, the difference will be mainly described and other description will be appropriately simplified or omitted.

In the second embodiment, as shown in FIG. 10, the configuration of the unit circuit P2 is different from the unit circuit P1 in the first embodiment. That is, the unit circuit 22 does not include a first transistor Tr1. A first electrode E1 of a capacitor element C1 is directly connected to a capacitor line 30. Further, in FIG. 10, a scanning line 3 includes only one wiring. The wiring corresponds to a light emitting control line 3W in the first embodiment. In this way, in the second embodiment, the scanning line 3 and the light emitting control line 3W are the same. The “scanning line” defined in the accompanying claims includes the “scanning line 3” or “light emitting control line 3W” in FIG. 10 corresponding thereto, in the second embodiment.

Further, in the second embodiment, as shown in FIG. 10, a third transistor Tr3 is connected to an end part of the capacitor line 30. The third transistor Tr3 is an N channel type and is a switching element which conducts the capacitor line 30 and a supply line (not shown) of a reference electric potential VST.

A source of the third transistor Tr3 is connected to the supply line, and a drain thereof is connected to the end part of the capacitor line 30. Further, a gate of the third transistor Tr3 is connected to a signal line 35. Thus, if a charging control signal GC[i] which is supplied to the signal line 35 transits to an active state, the third transistor Tr3 which belongs to an i-th row is a turned on state to conduct the supply line and the capacitor line 30, whereas if the charging control signal GC[i] transits a non-active state, the third transistor Tr3 which belongs to the i-th row is in a turned off state to cut off the conduction of the supply line and the capacitor line 30.

As understood according to the above description, the signal line 35 in the second embodiment may be considered as at least functionally the same element as the charging control line 3C in the first embodiment.

It is obvious that the second embodiment as described above has a function effect which is not essentially different from that of the first embodiment. That is, in the second embodiment, according to the state of the charging control signal GC[i] which is supplied to each signal line 35, it is determined whether each capacitor line 30 becomes a reference electric potential or a floating state other than the above characteristic. There is no essential difference between the configuration in FIG. 10 and the configuration in FIG. 2, and an operation thereof may be performed according to completely the same timing chart as in FIG. 3. (In this case, the GC[1], GC[2], GC[3], . . . in FIG. 3 is changed in meaning. That is, the signals GC[1], GC[2], GC[3], . . . are supplied to the signal line 35 in the second embodiment, whereas the signals GC[1], GC[2], GC[3], . . . are supplied to the charging control line 3C in the first embodiment.)

The number of the signal lines 35 which are not selected is basically freely determined in the second embodiment, which is the same as the first embodiment, and as the number of the capacitor elements C1 involved in charging and discharging is adjusted to be increased or decreased, and thus, luminance of all the images may be easily adjusted.

Further, according to the second embodiment, compared with the first embodiment, since the number of the transistors to be installed may be reduced, reduction in the cost for installation or reduction in size due to non-installation of the transistor in the unit circuit may be realized, and thus, high definition and a variety of effects may be obtained.

The embodiments according to the invention are described hereinbefore, but the electro-optical apparatus according to the invention is not limited to the above described embodiments, which may have a variety of modifications.

(1) In the first and second embodiments as described with reference to FIGS. 3, 6 and 7, the relation between the location of the capacitor element C1 which is not involved in the charging and discharging and the location of the electro-optical element 8 which is the light emitting target is described, but the invention is not limited to the above described embodiments.

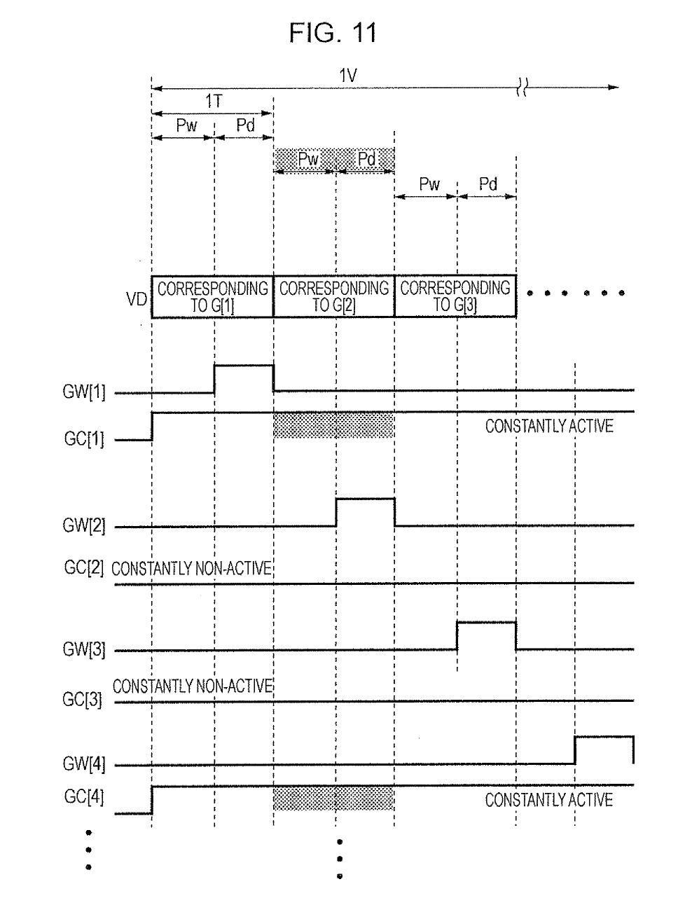

For example, the electro-optical apparatus 10 according to the embodiments may operate according to a timing chart shown in FIG. 11 (hereinafter, the first embodiment is exemplified for simplicity of description).

That is, firstly, in the writing period Pw shown in the leftmost side in FIG. 11, the scanning line driving circuit 200 supplies the active charging control signals CG[1], CG[4], . . . , CG[m] to the charging control lines 3C other than the charging control lines 3C included in the scanning lines 3 of the second and third rows. Accordingly, the first transistor Tr1 located in each row other than the second and third rows is in a turned on state to thereby conduct the capacitor element C1 belongs to each row and the supply line of the reference electric potential VST.

Hereinafter, under such a situation, there is no difference compared with the first embodiment such that the data electric potential generating unit 301 supplies the data electric potential VD[j] to each data line 6 and electric charges corresponding thereto are stored in the capacitor element C1 corresponding to the first transistor Tr1 which is in the turn on state.

In this respect, in FIG. 11, the charging control lines 3C which belong to the second and third row which are not selected, in the above description are not to be constantly selected thereafter. Contrarily, the charging control line 3C which is the selection target in the above description is to be constantly selected thereafter. This is irrelevant to concurrently performing an operation in which the electro-optical elements 8 which are the light emitting targets are sequentially selected according to line-sequential selection of the light emitting control line 3W.

This is based on the operation that the supply of the charging control signal GC[i] for the charging control line 3C and the supply of the light emitting control signal GW[i] for the light emitting control line 3W may be independently performed.

According to such an embodiment, as in the first embodiment, since the charging control lines 3C which become the non-selection and selection targets are not momentarily changed, and the charging control lines 3C which are the non-selection targets are constantly fixed to the non-selection targets, and the charging control lines 3C which are the selection targets are constantly fixed to the selection targets, reduction in power consumption or the like can be achieved.

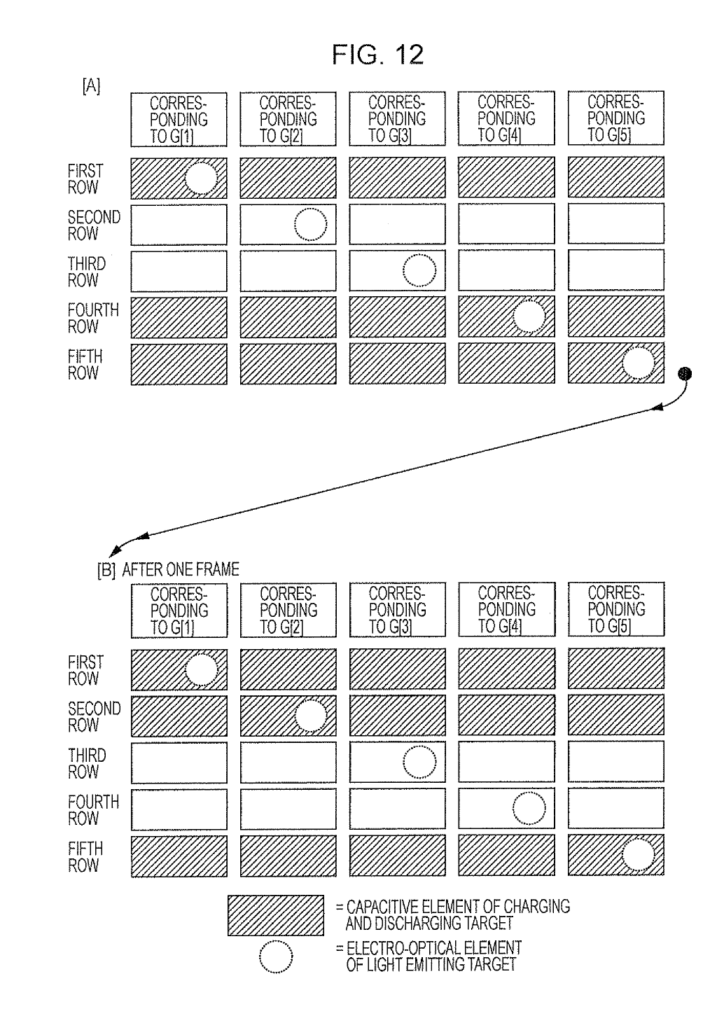

(2) For relation between the location of the capacitor element C1 which is not involved in the charging and discharging and the location of the electro-optical element 8 of the light emitting target may be realized as an example as shown in FIGS. 12A and 12B (hereinafter, the first embodiment is exemplified for simplicity of description). FIGS. 12A and 12B, which is similar to FIG. 6, is a diagram for illustrating a temporal change in relation between locations of the capacitor elements C1 which become charging and discharging targets in the case where the unit circuit exists in the fifth row and the first column and locations of the electro-optical elements 8 which become light emitting targets.

In FIG. 12A, similarly to the (1), the charging control lines 3C which belong to the second and third rows are not selected, that is, the capacitor elements C1 which belong to these rows, do not become the charging and discharging targets. Here, FIG. 12A illustrates non-selection and selection states of the charging control lines 3C in the first one vertical period. As indicated as an arrow or the like in FIGS. 12A and 12B, in FIG. 12B illustrating the next one vertical period, the charging control lines 3C which are the non-selection targets are changed from the second and third rows to the third and fourth rows.

If such a changing manipulation is repeatedly performed, from an overall point of view (or in view of time until the charging control lines 3C which are the non-selection targets are completely selected), any electro-optical element 8 may be driven under the same electric current supply condition, and thus, reduction in luminance irregularity which is the same as in the first embodiment may be obtained.

In addition, in such an operation example in FIGS. 12A and 12B, as in the first embodiment, since the charging control lines 3C which are the selection targets are not changed for every horizontal period, and since the charging control lines 3C which are the selection targets are changed for every vertical period, the number of the above changes is reduced compared with the first embodiment. According to the operation example in FIGS. 12A and 12B, the above described reduction in power consumption may be obtained.

In this modified example, a case that the charging control lines 3C which are the non-selection and selection targets are changed for every predetermined period is included in the range of the invention. The “predetermined period” defined in the modified example includes, for example, a variety of cases such as five horizontal periods or three frame periods, as well as the above described case that the period corresponds to one frame.

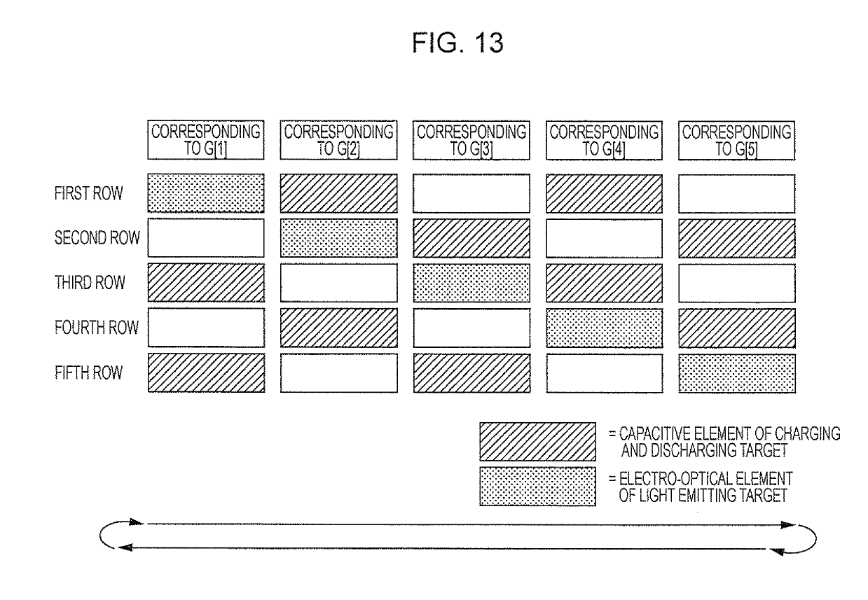

(3) Further, location relation of the capacitor elements C1 which are not involved in the charging and discharging and the electro-optical elements 8 which are the light emitting targets may be realized as an example as shown in FIG. 13.

FIG. 13, which is different from FIGS. 11 and 12 and is similar to FIG. 6, illustrates an example that the capacitor elements C1 which are the charging and discharging targets for every horizontal period are changed. In this case, the capacitor elements C1 which are the charging and discharging targets are arranged in every second row when seen from the capacitor element 8 which is the light emitting target.

As described above, the “predetermined location relation” in this modified example may include a variety of “location relations”.

(4) In the first and second embodiments, the charging target in the “i. Writing operation” is the capacitor element C1 included in the unit circuit P1 or P2, but the invention is not limited thereto.

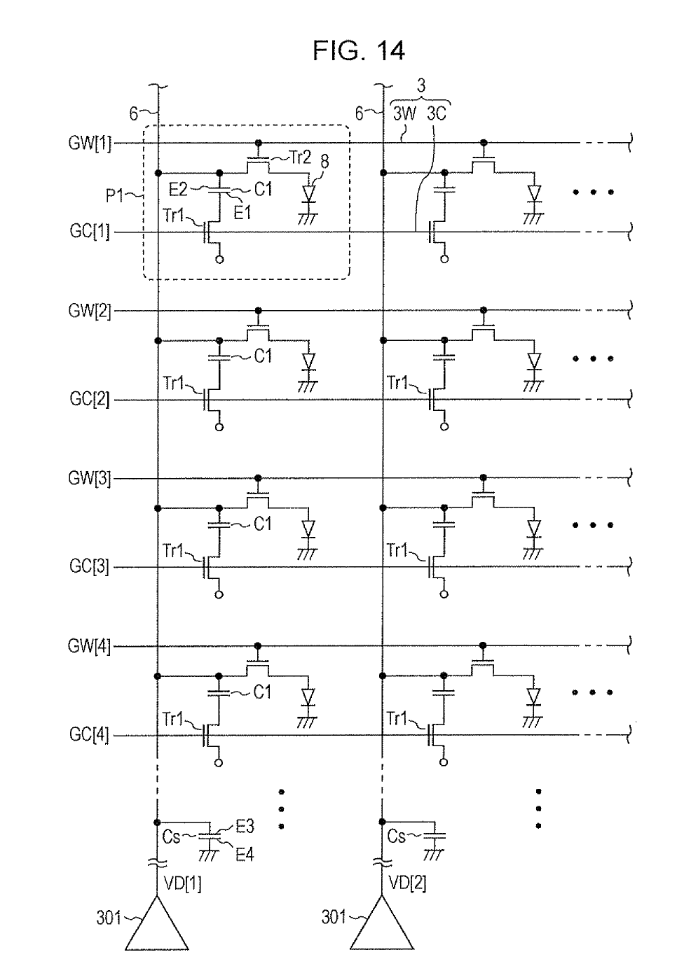

For example, as shown in FIG. 14, an auxiliary capacitor element Cs may be connected to each data line 6. The capacitor element Cs has one electrode E3 connected to the data line 6, and the other electrode E4 connected to an electric potential line which is supplied with a fixed electric potential. FIG. 14 illustrates an example in which the capacitor element Cs is added to the configuration of the first embodiment in FIG. 2, but the capacitor element Cs may be added to the configuration of the second embodiment in FIG. 10.

In such a modified example, in the writing period Pw in each unit period 1T shown in FIG. 3 or 11, the auxiliary capacitor element Cs is charged in addition to the predetermined capacitor element C1. Further, in the driving period Pd in each unit period 1T as shown FIG. 3 or 11, electric charges from the auxiliary capacitor element Cs are supplied to the unit circuits P1 corresponding to the auxiliary capacitor element Cs.

According to such a modified example, even in the case where a total value of capacitance of the capacitor element C1 connected to the data line 6 corresponding to one electro-optical element 8 is insufficient for obtaining a sufficient light emitting amount of the electro-optical element 8, the capacitance of the auxiliary capacitor element Cs may be used, to thereby compensate the insufficient capacitance.

### Application

Next, an electronic device to which the electro-optical apparatus 10 according to the embodiments is applied will be described hereinafter.

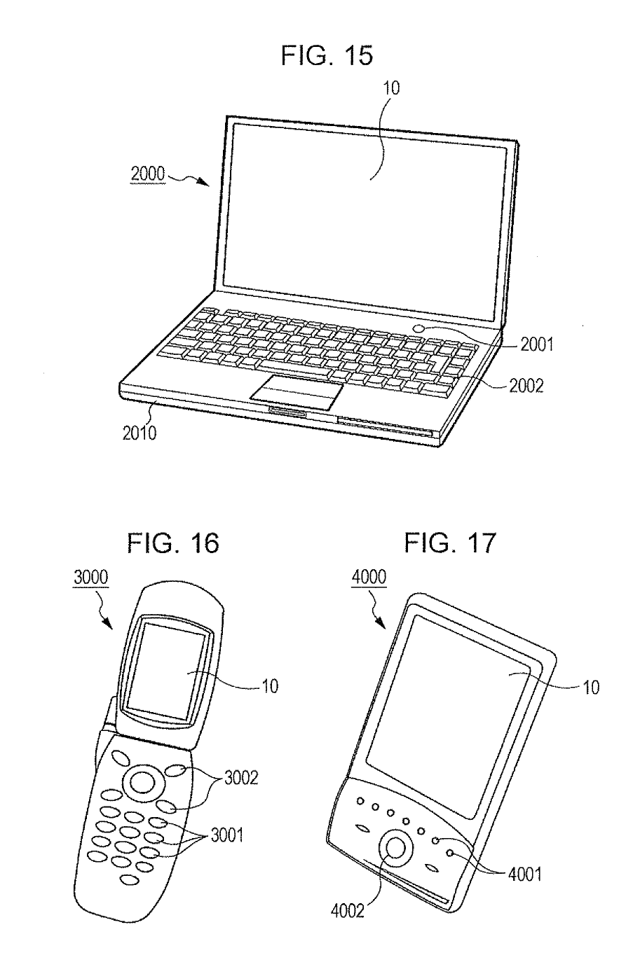

FIG. 15 is a perspective view illustrating a configuration of a mobile personal computer in which the electro-optical apparatus 10 according to the embodiments is applied to an image display. A personal computer 2000 includes the electro-optical apparatus 10 which is a display apparatus, and a main body 2010. A power switch 2001 and a keyboard 2002 are installed in the main body 2010.

FIG. 16 illustrates a cellular phone to which the electro-optical apparatus 10 according to the embodiments is applied. A cellular phone 3000 includes a plurality of manipulation buttons 3001, scroll buttons 3002, and the electro-optical apparatus 10 which is a display apparatus. By manipulating the scroll buttons 3002, a screen displayed in the electro-optical apparatus 10 is scrolled.

FIG. 17 illustrates a PDA (Personal Digital Assistant) to which the electro-optical apparatus 10 according to the embodiments is applied. A PDA 4000 includes a plurality of manipulation buttons 4001, a power switch 4002, and the electro-optical apparatus 10 which is a display apparatus. If the power switch 4002 is manipulated, a variety of information such as an address list or a schedule book is displayed in the electro-optical apparatus 10.

As electronic devices to which the electro-optical apparatus according to the invention is applied, there are exemplified digital still cameras, televisions, video cameras, car navigation apparatuses, pagers, electronic notebooks, electronic paper, calculators, word processors, work stations, television telephones, POS terminals, video players, devices having a touch panel, or the like, in addition to those as shown in FIG. 15 to FIG. 17.

1. An electro-optical apparatus comprising:
a plurality of unit circuits which is arranged to correspond to intersections of a plurality of scanning lines and a plurality of data lines;
a plurality of control lines which is arranged to correspond to each of the plurality of scanning lines;
a scanning line driving circuit which sequentially selects one scanning line in every driving period included in a unit period, and selects all or a part of the plurality of control lines; and
a data line driving circuit which outputs, to the respective data lines, data electric potentials corresponding to gradation data of the unit circuits corresponding to the scanning line selected in the driving period in the unit period, in every writing period which is included in each unit period before the driving period begins,
wherein each of the plurality of unit circuits includes:
an electro-optical element which provides gradation corresponding to the data electric potential; and
a capacitor element which has a first electrode connected to a capacitor line through a first switching element and a second electrode connected to the electro-optical element through a second switching element;
wherein the first switching element is switched on when the control line is selected in the writing period to conduct between the capacitor line and the first electrode, and
wherein the second switching element is switched on when the scanning line is selected by the scanning line driving circuit in the driving period to conduct the second electrode and the electro-optical element.

2. The electro-optical apparatus according to claim 1, wherein all the plurality of control lines is not concurrently selected in one writing period.

3. The electro-optical apparatus according to claim 1, wherein the control line which is not selected in the one writing period among the plurality of control lines is regulated by a predetermined location relation with respect to the one scanning line selected in the driving period corresponding to the writing period, and the predetermined location relation is constantly the same regardless of whether the one selected scanning line is any scanning line among the plurality of scanning lines.

4. The electro-optical apparatus according to claim 3, wherein the predetermined location relation includes a relation that the one control line corresponding to the one scanning line adjacent to the one scanning line selected in the driving period is constantly not selected.

5. The electro-optical apparatus according to claim 1, wherein the control line selected among the plurality of control lines is constant for a predetermined period.

6. The electro-optical apparatus according to claim 5, wherein the predetermined period corresponds to one frame.

7. An electro-optical apparatus comprising:
a plurality of unit circuits which is arranged to correspond to intersections of a plurality of scanning lines and a plurality of data lines;
a capacitor line which is arranged to correspond to each of the plurality of scanning lines;
a scanning line driving circuit which sequentially selects one scanning line in every driving period included in a unit period; and
a data line driving circuit which outputs, to the respective data lines, data electric potentials corresponding to gradation data of the unit circuits corresponding to the scanning line selected in the driving period in the unit period, in every writing period which is included in each unit period before the driving period begins,
wherein each of the plurality of unit circuits includes:
an electro-optical element which provides gradation corresponding to the data electric potential;
a capacitor element which has a first electrode connected to the capacitor line and a second electrode; and
a second switching element which is arranged between the second electrode of the capacitor element and the electro-optical element and is switched on when the scanning line is selected by the scanning line driving circuit in the driving period to conduct the second electrode and the electro-optical element,
wherein each capacitor line is connected to a plurality of third switching elements which correspond to the each capacitor line and is switched on in the writing period to conduct between the each capacitor line and a supplying line of a reference electric potential.

8. An electronic device comprising the electro-optical apparatus according to claim 1.

9. A driving method of an electro-optical apparatus including a plurality of control lines which is arranged to correspond to each of a plurality of scanning lines, and a plurality of unit circuits, each unit circuit including an electro-optical element which provides predetermined gradation according to discharging of a capacitor element in the each unit circuit, the method comprising:
outputting a data electric potential to a plurality of data lines which are extended across the plurality of scanning lines;
selecting all or a part of the plurality of control lines to conduct a first switching element between the capacitor element in the unit circuit corresponding to the selected control line and a capacitor line, so as to store electric charges according to the data electric potential in the capacitor element; and
selecting one scanning line to conduct a second switching element between the electro-optical element in the unit circuit corresponding to the selected scanning line and the capacitor element.

10. An electronic device comprising the electro-optical apparatus according to claim 2.

11. An electronic device comprising the electro-optical apparatus according to claim 3.

12. An electronic device comprising the electro-optical apparatus according to claim 4.

13. An electronic device comprising the electro-optical apparatus according to claim 5.

14. An electronic device comprising the electro-optical apparatus according to claim 6.

15. An electronic device comprising the electro-optical apparatus according to claim 7.
